(19) United States
(12) Patent Application Publication
(10) Pub. No.: US 2004/0051690 A1
(43) Pub. Date: Mar. 18, 2004

(54) Driving circuit and method of driving display device

(76) Inventor: Yi-chen Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,566

(22) Filed: Oct. 31, 2002

(30) Foreign Application Priority Data
Sep. 12, 2002 (TW) 91120826

(51) Int. Cl. G09G 3/36

(52) U.S. Cl. 345/92

(57) ABSTRACT

A driving circuit and a method of driving a display device are provided. The driving circuit is incorporated into the original driving circuit of a conventional display device. A discharging unit is added to the driving unit that drives each light-emitting device. The discharging unit is connected to the next scan line. As the driving circuit switches the scan lines one by one, the newly added discharging unit discharges-the light-emitting device as soon as the next scan line is switched on. Discharging the light-emitting device prevents the accumulation of charges that may lead to material deterioration as well as an increase in electrical resistant. Furthermore, the drain terminal of the discharging unit may be connected to a ground or a negative voltage terminal. If the drain terminal is connected to a negative voltage terminal, discharging rate may increase further leading to higher performance and a longer working, life for the light-emitting device.

### CROSS REFERENCE TO RELATED APPLICATIONS

This application claims the priority benefit of Taiwan application serial no. 91120826, filed Sep. 12, 2002.

### BACKGROUND OF INVENTION

1. Field of Invention

The present invention relates to the driving circuit of a display device. More particularly, the present invention relates to a driving circuit and a method of driving a display device capable of preventing a rise in the driving voltage of a light-emitting device.

2. Description of Related Art

Early in the twentieth century, dynamic images were chained together to form movies. Not long after inventing the cathode ray tube (CRT), commercial broadcasting ensued leading to the popularization of television. In recent decades, cathode ray tubes have also been adopted by the computer industry as an interface between human and personal computer. Most desktop monitors have an identical operating principle as the CRT. However, radiation hazards and bulkiness due to the electron gun design inside the CRT have prompted the invention of some other novel display devices such as flat panel displays.

There are many types of flat panel displays. The most common types of flat panel displays include liquid crystal display (LCD), field emission display (FED), organic light-emitting diode (OLED) and plasma display panel (PDP). Organic light-emitting diode (OLED), also known as organic electroluminescence display (OELD), is a self-illuminating type of display device. OLED is direct current low voltage driven and has a high luminosity, a high operating efficiency, a high contrast and a small weight. Moreover, many color hues from the three primary colors red (R), green (G) and blue (B) to white can be produced. Consequently, OLED is often regarded as the flat panel display with the most promising developmental potential. Aside from light-weight and high resolution like an LCD, self-illuminating like an LED, quick response and the production of energy-saving cool light, the advantages of OLED also include a wide viewing angle, beautiful color contrast and low production cost. Hence, OLED has many applications including the back illumination of an LCD or an indicator panel, mobile phone, digital camera as well as personal digital assistant.

According to the driving method, OLED can be divided into passive matrix driven type and active matrix driven type. The advantages of a passively driven OLED include structural simplicity and freedom from using a thin film transistor (TFT) as the driver. Hence, production cost of a passively driven OLED is relatively low. However, passive OLED has a lower image resolution and consumes considerable amount of energy. Thus, too much energy will be consumed, working life will be shortened and display clarity will be compromised when the passive OLED is used to fabricate a-large display panel. On the other hand, although an active matrix driven OLED is slightly more expensive to produce, the active OLED design can be applied to fabricate a larger display with a larger viewing angle, a higher luminosity and a quicker response to signals.

Flat panel displays may be further classified, according to the driving type, into a voltage driven type or a current driven type. In general, the voltage driven type is mostly applied to TFT-LCD. Different voltages are applied to various data lines to produce different levels of gray scale so that a full colorization is obtained. Since the voltage driven type TFT-LCD has been developed for quite some time, TFT-LCD works quite reliably and has a low production cost. The current driven type is frequently applied to OLED display. Different currents are applied to the data lines to produce different gray scale so that a full colorization is obtained. However, new circuits and IC designs are required if current is used as the medium for driving pixels. Since such design and development cost is high, cost will be reduced considerably if the voltage driven circuit for driving TFT-LCD can somehow be used to drive the OLED.

FIG. 1 is a diagram showing the driving circuit of a pixel inside a conventional display device. As shown in FIG. 1, the pixel 100 includes a driving circuit 110 and a light-emitting device (OLED) 120. The driving circuit includes a first thin film transistor (TFT1), a capacitor (C) and a second thin film transistor (TFT2). The transistor TFT2 is a driving thin film transistor for producing a current that drives the OLED 120 to emit light. The drain terminal of the transistor TFT1 is coupled to a data voltage (V_{data}) terminal, the gate terminal of the transistor TFT1 is coupled to a scan data voltage (V_{scan}) terminal and the source terminal of the transistor TFT1 is coupled to scan a first terminal of the capacitor (C) and the gate terminal of the transistor TFT2. The drain terminal of the transistor TFT2 is coupled to a positive voltage (V_{dd}) terminal and the source terminal of the transistor TFT2 is coupled to the positive terminal of the OLED 120. The second terminal of the capacitor (C) is coupled to a voltage (Vₛₛₗ) terminal. The voltage (Vₛₛₗ) terminal is supplied with a negative voltage or a ground potential. The negative terminal of the OLED 120 is coupled to a voltage (Vₛₛ) terminal. The voltage (Vₛₛ) terminal is also supplied with a negative voltage or a ground potential.

FIG. 2 is a timing diagram showing voltage/time relationship for the voltages V_{dd}, V_{scan} and V_{data} in the conventional driving circuit shown in FIG. 1. The drain current formula for operating the second thin film transistor (TFT2) in the saturated region is given by:

I_{ds}=(½)×k2×(V_{CS}−Vₜₕ₂)²=(½)×k2×(V_{gs}−V_{d2}−Vₜₕ₂)²

where, k2=μₙ×Cₒₓ×(W/L)², μₙ is the electron mobility and Cₒₓ is the gate capacitance per unit area (μₙ and Cₒₓ have constant values), (W/L)² is the channel width/length ratio for the second thin film transistor (TFT2), V_{g2} is the gate voltage of the second thin film transistor (TFT2), V_{d2} is the drain voltage of the second transistor (TFT2) and Vₜₕ₂ is the threshold voltage of the second thin film transistor (TFT2).

According to the aforementioned formula, V_{d2}=Vₛₛ+VOLED where VOLED is the voltage supplied to the light-emitting device 120. If the value of the voltage VOLED is unstable, current driving the light-emitting device 120 will vary. Ultimately, this may lead to a reduction in the working life of the light-emitting device 120.

### SUMMARY OF INVENTION

Accordingly, one object of the present invention is to provide a driving circuit and a method of driving a display device. The driving circuit is incorporated into the original driving circuit of a display device such that the driving unit of each light-emitting device has an additional thin film transistor therein. The gate of each thin film transistor is connected to the next scan line. When the driving circuit switches on the scan lines one by one, the added thin film transistor will discharge from the light-emitting device immediately after switching on the next scan line. Hence, a rise in the driving voltage of the light-emitting device is prevented and working life of the device is increased. In addition, the drain terminal of the added thin film transistor may connect with a ground potential or a negative voltage. If the drain terminal is connected to a negative voltage, discharging efficiency from the light-emitting device will improve and extend the working life of the device even further.

To achieve these and other advantages and in accordance with the purpose of the invention, as embodied and broadly described herein, the invention provides a driving circuit and a display device using the driving circuit. The driving circuit drives a light-emitting device. The driving circuit for the display device includes a light-emitting device driving unit and a discharging unit. The light-emitting device driving unit is coupled to the light-emitting device for providing a driving current to the light-emitting device selectively. The discharging unit is coupled to the light-emitting driving unit for discharging the light-emitting device according to the voltage level of a control signal as soon as the light-emitting device driving unit provides a current to drive the light-emitting device.

he driving circuit further includes a light-emitting device selection unit coupled to the light-emitting device driving unit for receiving a scan signal and a data signal. When the scan signal and the data signal are at logic level “1”, the light-emitting device selection unit enables the light-emitting device driving unit so that the light-emitting device driving unit provides a driving current to the light-emitting device.

According to this invention, the control signal for the driving circuit is triggered by the scan signal of the next pixel. When the scan signal of the next pixel is between logic level “1”, the discharging unit discharges the light-emitting device. In addition, the discharging unit is coupled to a ground potential or a negative voltage so that the light-emitting device may discharge to the ground or the negative voltage line.

This invention also provides a method of driving a display device. The display device has a plurality of pixels. The driving method is employed to drive the light-emitting device in each pixel. A driving current is provided selectively to drive one of the aforementioned light-emitting devices. According to the voltage level of a control signal, the light-emitting device discharges when driven by a driving current.

In the aforementioned method, a driving current is submitted to a particular light-emitting device according to a scan signal and a data signal provided to the display device. When the scan signal and the data signal are at logic level “1”, a driving current is submitted to the light-emitting device. In the meantime, the control signal for discharging the light-emitting device is derived from the scan signal of the next pixel.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing the driving circuit of a pixel inside a conventional display device;

FIG. 2 is a timing diagram showing voltage/time relationship for the voltages V_{dd}, V_{scan}, V_{data} and V_{g2} in the conventional driving circuit shown in FIG. 1; and

FIG. 3 is a diagram showing a driving circuit for a pixel inside a display device according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

This invention relates to the driving circuit of a display device. The driving circuit enclosed inside the display device drives a light-emitting device to produce light. The light-emitting device can be an organic light-emitting diode (OLED), for example. The light-emitting device emits light energy when electrons and holes inside the device are recombined in pairs. Therefore, after applying a voltage to the light-emitting device for some time, material constituting the light-emitting device may degrade leading to greater electrical resistance due to prolonged charge accumulation. This often results in a rise in the driving voltage. With a rise in the driving voltage for the light-emitting device, current sent to drive the light-emitting device will be reduced and performance of the device will be compromised. Ultimately, useful life of the light-emitting device is reduced.

The driving circuit of this invention is installed inside the original-driving circuit of a display device. A thin film transistor is incorporated to the driving unit of each pixel. The gate of each thin film transistor is connected to the next scan line. When the driving circuit switches on the scan lines one by one, the added thin film transistor will discharge from the light-emitting device immediately after switching on the next scan line so that charge accumulation is reduced. Hence, a rise in the driving voltage of the light-emitting device is prevented and working life of the device is increased. In addition, the drain terminal of the added thin film transistor may connect with a ground potential or a negative voltage. If the drain terminal is connected to a negative voltage, discharging efficiency from the light-emitting device will improve and extend the working life of the device even further.

FIG. 3 is a diagram showing a driving circuit for a pixel inside a display device according to one preferred embodiment of this invention. As shown in FIG. 3, the pixel 300 includes a driving circuit 310 and a light-emitting device 320. The light-emitting device 320 can be an organic light-emitting diode (OLED) also known as an organic electroluminescence display (OELD) or a molecular light-emitting diode. The driving circuit 310 further includes a light-emitting device selection unit 311 and a light-emitting device driving unit 313. The light-emitting device selection unit 311 comprises a first thin film transistor (TFT1) and a capacitor (C), for example. The light-emitting device driving unit 313 comprises a second thin film transistor (TFT2), for example. The second thin film transistor (TFT2), also known as a driving thin film transistor, produces a driving current to drive the light-emitting device 320.

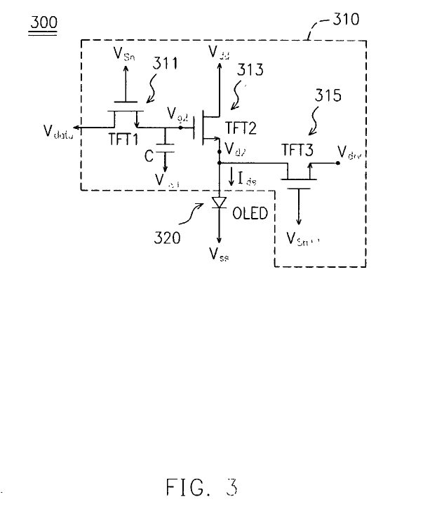

The driving circuit 310 of this invention further includes a discharging unit 315. The discharging unit 315 is connected to the drain terminal of the second thin film transistor (TFT2). Each pixel in the display device including the pixel 300 has a data line and a scan line. The timing relationship of various voltage terminals V_{dd}, V_{scan} and V_{data} within the driving circuit 310 is similar to the one shown in FIG. 2. A high voltage level and a low voltage level will appear once on each scan line of a corresponding pixel. A complete cycle, which is the summation of time in the high voltage level and the low voltage level, is called a time frame (indicated by the letter T in FIG. 2). For example, a time frame is the familiar 1/60 second. That is, the light-emitting device operates at a frequency of 60 Hz and each time frame constitutes a pixel image.

The discharging unit 315 is connected to a control signal. The discharging unit 315 is activated by the control signal. For example, if the control signal is at a high voltage level or logic level “1”, the light-emitting device 320 will be discharged. The discharge period is largely determined by the design requirement. In the preferred embodiment of this invention, the control signal for the discharging unit 315 is provided by the next scan line corresponding to the current driving circuit 310. The light-emitting device 320 will discharge when the next scan line voltage is at a high voltage level. Hence, the effect due to charge accumulation inside the light-emitting device 320 will be minimized and operating life of the device will be extended.

The discharging unit 315 according to this invention may be implemented using a third thin film transistor (TFT3), for example. However, this is not the only means of implementation. The discharging unit 315 may comprise an assembly of various devices that performs a similar function. The main criterion for any circuit setup is the capacity for a high voltage level to trigger the circuit into discharging excess charges from the light-emitting device 320.

Assume n scan lines correspond to the pixel 300. The drain terminal of the first thin film transistor (TFT1) is connected to the data voltage V data The gate terminal of the first thin film transistor (TFT1) is coupled to the nth scan line having a scan voltage Vₛₙ. The source terminal of the transistor (TFT1) is connected to a first terminal of the capacitor (C) and the gate terminal of the second thin film transistor (TFT2). The second terminal of the capacitor (C) is connected to a voltage source Vₛₛₗ. The voltage source Vₛₛₗ is either a negative voltage or a ground potential. The source terminal of the second thin film transistor (TFT2) is connected to a positive voltage source V_{dd}. The drain terminal of the second thin film transistor (TFT2) is connected to the positive terminal of the light-emitting device 320 and the source terminal of the third thin film transistor (TFT3). The drain terminal of the third-thin film transistor (TFT3) is connected to a voltage source V_{drv}. The gate terminal of the third thin film transistor (TFT3) is connected to the scan voltage source Vₛₙ₊₁ of the next scan line (that is, the (n+1)^{th} scan line). The negative terminal of the light-emitting device 320 is connected to a voltage source Vₛₛ. The voltage source Vₛₛ provides either a negative voltage or a ground potential.

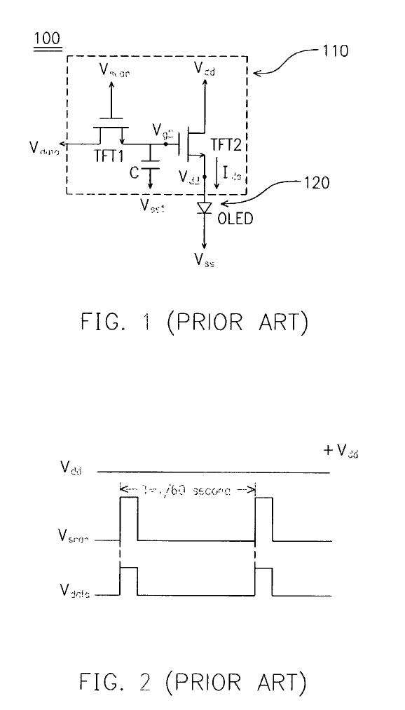

Due to charge accumulation through continuous operation, the driving voltage for driving the light-emitting device 320 will increase. To reduce the increase in driving voltage, a discharging unit 315 is incorporated into the conventional driving circuit as shown in FIG. 1 by connecting to the next scan line. Using the sequential scan line switching property of the driving circuit, the discharging unit 315 will discharge the light-emitting device 320 immediately after receiving an activation signal (a scan voltage transition from a low voltage level to a high voltage level) from the next scan line. By discharging the light-emitting device 320, charge accumulation effect on the driving voltage of the light-emitting device 320 is minimized.

For example, the third thin film transistor (TFT3) in FIG. 3 serves as the discharging unit 315. The gate terminal of the transistor (TFT3) is connected to the next scan line. In general, a high voltage level and a low voltage level will appear once on each scan line of a corresponding pixel to form a complete cycle or a time frame (indicated by the letter T in FIG. 2). A time frame is, for example, 1/60 second. That is, the light-emitting device operates at a frequency of 60 Hz and each time frame constitutes a pixel image. When the (n+1)^{th} scan line is ready to switch on, the newly added thin film transistor (TFT3) will discharge the light-emitting device 320 in the pixel 300 corresponding to the nth scan line. Ultimately, increase in the driving voltage of the light-emitting device 320 is prevented.

The aforementioned discharging unit 31 discharges the light-emitting device 320 to the ground. In another embodiment, the discharging unit 31 may connect to a negative voltage terminal to increase discharge efficiency. For example, the drain terminal of the third thin film transistor (TFT3) may be connected to a voltage source V_{drv} at a ground potential or a negative voltage. If the drain terminal is connected to a negative voltage, discharging rate from the light-emitting device will increase and working life of the display may increase.

When the scan voltage Vₛₙ of the nth scan line is at a high voltage level, the first thin film transistor (TFT1) will conduct. The source terminal of the second thin film transistor (TFT2) picks up the voltage V_{data}. The drain current formula for operating the second thin film transistor (TFT2) in the saturated region is given by:

I_{ds}==(½)×k2×(V_{g2}−V_{d2}−Vₜₕ₂)²

where k2=μₙ×Cₒₓ(W/L)², μₙ is the electron mobility and Cₒₓ is the gate capacitance per unit area (μₙ and Cₒₓ have constant values), (W/L)² is the channel width/length ratio for the second thin film transistor (TFT2), V_{g2} is the gate voltage of the second thin film transistor (TFT2), V_{d2} is the drain voltage of the second transistor (TFT2) and Vₜₕ₂ is the threshold voltage of the second thin film transistor (TFT2).

Here, V_{d2}=V₃₂₀+Vₛₛ, where V320 is the voltage at the positive terminal of the light-emitting device 320. According to the above formula, voltage V₃₂₀ will increase with operating period and lead to a reduction in the drain current Ids.

However, by switching the third thin film transistor (TFT3) on, the light-emitting device 320 will connect with the voltage V_{drv}. Since V_{drv} is either a ground potential or a negative voltage, the accumulated charges inside the light-emitting device 320 will be discharged and hence the driving voltage of the light-emitting device 320 will not increase with time.

In summary, this invention incorporates a discharging unit into the original driving circuit of a display device so that the light-emitting device is able to discharge when activated by the scan voltage from the next scan line. Thus, a rise in the driving voltage of the light-emitting device due to charge accumulation is prevented and the light-emitting device is able to maintain a constant luminosity throughout operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A driving circuit for a display device having a plurality of pixels, wherein the driving circuit is used for driving the light-emitting device in each pixel, the driving circuit comprising:
a light-emitting device driving unit coupled to the light-emitting device for providing a driving current to the light-emitting device selectively; and
a discharging unit coupled to the light-emitting device driving unit for discharging the light-emitting device according to the voltage level of a control signal as soon as the light-emitting device driving unit provides a driving current to the light-emitting device.

2. The driving circuit of claim 1, wherein the driving circuit may further include a light-emitting device selection unit coupled to the light-emitting device driving unit for receiving a scan signal and a data signal, and when the scan signal and the data signal are at logic level “1”, the light-emitting device selection unit enables the light-emitting device driving unit to provide a driving current to the light-emitting device.

3. The driving circuit of claim 2, wherein the control signal uses the scan signal from the next pixel.

4. The driving circuit of claim 3, wherein the discharging unit discharges the light-emitting device when the scan signal on the next pixel is at a logic level “1” or a high voltage level.

5. The driving circuit of claim 1, wherein the discharging unit is coupled to a ground potential so that electric charges are discharged from the light-emitting device to the ground.

6. The driving circuit of claim 1, wherein the discharging unit is coupled to a negative voltage so that electric charges are discharged from the light-emitting device to the negative voltage terminal.

7. The driving circuit of claim 1, wherein the discharging unit is a transistor and the transistor is switched on to discharge the light-emitting device according to the voltage level of the control signal.

8. The driving circuit of claim 7, wherein the gate terminal of the transistor is connected to the control signal terminal and the drain terminal of the transistor is connected to a ground potential so that electric charges in the light-emitting device discharge to the ground when the transistor is turned on by the control signal.

9. The driving circuit of claim 7, wherein the gate terminal of the transistor is connected to the control signal terminal and the drain terminal of the transistor is connected to a negative voltage terminal so that electric charges in the light-emitting device discharge to the negative voltage terminal when the transistor is turned on by the control signal.

10. The driving circuit of claim 1, wherein the light-emitting device includes an organic light emitting diode (OLED).

11. The driving circuit of claim 1, wherein the light-emitting device includes a molecular light-emitting diode.

12. A display device having a plurality of pixels, wherein each pixel has a driving circuit for driving the light-emitting device inside each pixel, the driving circuit comprising:
a light-emitting device driving unit coupled to the light-emitting device for providing a driving current to the light-emitting device selectively; and
a discharging unit coupled to the light-emitting device driving unit for discharging the light-emitting device according to the voltage level of a control signal as soon as the light-emitting device driving unit provides a driving current to the light-emitting device.

13. The display device of claim 12, wherein the driving circuit may further include a light-emitting device selection unit coupled to the light-emitting device driving unit for receiving a scan signal and a data signal, and when the scan signal and the data signal are at logic level “1”, the light-emitting device selection unit enables the light-emitting device driving unit to provide a driving current to the light-emitting device.

14. The display device of claim 13, wherein the control signal uses the scan signal from the next pixel.

15. The display device of claim 14, wherein the discharging unit inside the driving circuit discharges the light-emitting device when the scan signal on the next pixel is at a logic level “1” or a high voltage level.

16. The display device of claim 12, wherein the discharging unit inside the driving circuit is coupled to a ground potential so that electric charges are discharged from the light-emitting device to the ground.

17. The display device of claim 12, wherein the discharging unit inside the driving circuit is coupled to a negative voltage so that electric charges are discharged from the light-emitting device to the negative voltage terminal.

18. A method of driving a display device, wherein the display device has a plurality of pixels and the driving method is used for driving the light-emitting device inside each pixel, the driving method comprising the steps of:
providing a driving current to one of the light-emitting devices selectively; and
discharging the light-emitting device according to the voltage level of a control signal while the light-emitting device is driven by a driving current.

19. The driving method of claim 18, wherein the step of providing a driving current to one of the light-emitting devices selectively includes providing a driving current to the light-emitting device when a scan signal and a data signal sent to the display device are at a logic level “1” or a high voltage level.

20. The driving method of claim 19, wherein the control signal is provided by the scan signal of the next pixel in the display device.
